(19) United States
(12) Patent Application Publication
(10) Pub. No.: US 2026/0262671 A1
(43) Pub. Date: Sep. 10, 2026

(54) Plant-Based Composition

(71) Applicant: ADM WILD Europe GmbH & Co. KG, Eppelheim (DE)

(72) Inventors: Eckhard GUHL, Wiesloch (DE); Jasmin LUCAS, Gelnhausen (DE); Ricarda ENKE, Hamburg (DE); Matthias SASS, Oftersheim (DE)

(21) Appl. No.: 19/153,265

(22) PCT Filed: Feb. 1, 2024
(86) PCT No.: PCT/EP2024/052463

§ 371 Date: Aug. 1, 2025

(30) Foreign Application Priority Data
Feb. 1, 2023 (EP) 23154493.3

(51) Int. Cl. A23C 11/10; A23D 7/005; A23D 7/04; A23L 9/20

(52) U.S. Cl. CPC A23C 11/10; A23D 7/0053; A23D 7/04; A23L 9/20

(57) ABSTRACT

The present invention relates in one aspect to a composition comprising starch and one or more vegetable fats, wherein the composition does not contain palm fat, wherein the vegetable fat of the composition has a solid fat content from 15% to 25% at 20° C. The present invention relates in one aspect to a food-product additive and/or a food product comprising a composition of the invention, methods for producing a composition of the invention, the use of a composition of the invention in a food product, and a container comprising a composition of the invention.

### FIELD OF THE INVENTION

The present invention relates to a composition comprising starch and one or more vegetable fat, which does not contain palm fat, wherein the vegetable fat of the composition has a solid fat content at 20° C. from 15% to 25%, a food-product additive and a food product comprising the composition, methods for producing the composition, the use of the composition in a food product and a container comprising the composition.

### BACKGROUND OF THE INVENTION

Nowadays public interest is focused on the desire to eat healthy and to lower the intake of animal-based food products, such as meat and dairy products. It is further focused on nutritional aspects of processed foods such as energy density, fat-free and without cholesterol, as well as absence of potential allergens. There is also an increasing number of vegans, and food products completely absent of animal-derived products are required. The consumer's demand has led to the development of plant-based food products, such as plant-based meat analogues and plant-based dairy analogues.

Studies have shown that the consumption of vegetable oils has many benefits for heart health and is recommended as an alternative to sources of saturated fat, such as lard, butter, and animal fat in general. This is because vegetable oils contain more polyunsaturated fats, which reduces the risk of cardiovascular diseases.

Common plant-based food products are based on proteins and contain further stabilizers and/or emulsifiers to mimic the properties of the respective animal-based food. However, such products lose acceptance in today's market, since consumers are looking for fewer additives in products, in an attempt to live healthier lifestyles.

Furthermore, it is a trend with consumers to avoid the use of palm oil and palm oil derivatives as vegetable fat source.

WO 2022/203577 relates to a dairy-analogue composition comprising a fat composition, starch, water, and optionally non-animal protein.

WO 2022/164378 describes a cheese-analogue composition comprising a fat composition, starch, water, and optionally non-animal protein.

US 2019/0116852 relates to a plant-based cream comprising water, fat, a stabilizer, and plant-based milk or milk powder. However, the fat may be palm oil or palm kernel oil.

M. P. Perez et al., Journal of Texture Studies 2014, vol. 45, pages 396 to 407 study the partial coalescence in oil-in-water emulsions prepared with skimmed cow milk and non-dairy fats.

L. Grossmann et al., Trends in Food Science & Technology 2021, vol. 118, pages 207 to 229 describe plant-based ingredients and processing operations for the preparation of plant-based cheese analogs.

However, the plant-based food products known today contain food ingredients, which do not meet the consumer's desire of food products originating from plants. In view of a healthy diet, consumers are increasingly looking for delicious alternatives which can mimic a dairy-based food, contains only small amounts of additives, has a low protein content and avoids allergens.

### SUMMARY OF THE INVENTION

The object of the present invention is therefore to provide a composition, having a low protein content and desirable organoleptic characteristics and can mimic a dairy-based food and contains only small amounts of additives, has a low protein content and avoids allergens.

Said object is solved by a composition comprising 10 to 35 wt % of vegetable fat based on the total weight of the composition, 65 to 90 wt % of water phase based on the total weight of the composition, summing up to a total of 100 wt %, wherein 3 to 31 wt % of the total weight of the water phase is nOSA starch, wherein the vegetable fat does not contain palm fat, and wherein the solid fat content (SFC) of the vegetable fat of the composition at 20° C. is from 15 to 25%.

Surprisingly, the composition in accordance with the present invention is able to mimic a dairy-based food and has favorable organoleptic characteristics. The composition further contains less additives and allergens compared to presently available products.

Said object is further solved by a food-product additive comprising the composition, a food product comprising the composition, the use of said composition for addition to a food product, a container comprising said composition, and a method of producing the composition.

Preferred embodiments are described in the dependent claims 2 to 11, 14, and 17.

### SHORT DESCRIPTION OF THE FIGURES

FIG. 1 shows a flow chart of the preparation method of Comparative Example 1.

FIG. 2. shows a flow chart of the preparation method of Comparative Example 2.

FIG. 3. shows a flow chart of the preparation method of Example 3.

FIG. 4. shows the results of order of precedence acc. Kramer of Comparative Examples 1 and 2, Example 3 and cow's cream.

### DETAILED DESCRIPTION

The composition of the present invention comprises a lipid phase (oil and/or fat phase) and a water phase, comprising 3 to 31 wt % of nOSA starch based on the total weight of the water phase of the composition.

An emulsion is a mixture of two or more liquids. Those liquids usually separate. According to the oil-in-water emulsion composition of the present invention, the liquids are lipid phase, which comprises fat, oil and lipophilic substances and water phase, which comprises water and hydrophilic substances.

As an example: if the total weight of the composition is 100 g, of which 30 g is vegetable fat, 60 g is water and 10 g ( 1/7×100% of wt of water phase) is nOSA starch. The 10 g nOSA are part of a total of 70 g water phase.

Starch is a polymeric carbohydrate consisting of numerous glucose units joined by glycosidic bonds. This polysaccharide is produced by most green plants for energy storage. Worldwide, it is the most common carbohydrate in human diets, and is contained in large amounts in staple foods such as wheat, potatoes, maize (corn), rice, and cassava (manioc). Pure starch is a white, tasteless and odorless powder that is insoluble in cold water or alcohol. It consists of two types of molecules: the linear and helical amylose and the branched amylopectin. Depending on the plant, starch generally contains 20 to 25 wt % amylose and 75 to 80 wt % amylopectin.

Starches can be modified from its native state, for example, by physically, enzymatically, or chemically treating native starch to change its properties. Starches are modified to enhance their performance in different applications. Starches may be modified to increase their stability against excessive heat, acid, shear, time, cooling, or freezing; to change their texture; to decrease or increase their viscosity; to lengthen or shorten gelatinization time; or to increase their visco-stability.

One modified starch is starch sodium octenyl succinate (E1450), wherein starch is modified with N-octenyl succinic anhydride. In the present invention the term “nOSA starch” is used for starch sodium octenyl succinate.

In a preferred embodiment in combination with any of the above or below embodiments, nOSA starch is present in an amount of 3 to 31 wt %, more preferably 4 to 23 wt %, in particular 5.5 to 18.5 wt %, based on the total weight of the water phase of the composition.

The composition of the present invention further comprises 10 to 35 wt % of vegetable fat, based on the total weight of the composition.

The terms “vegetable fat”, “vegetable oil”, “plant-based fat”, and “plant-based oil” are used synonymously and refer to any fat or oil that has a plant origin. Vegetable fats are obtained from seeds or other plant parts through milling, pressing and/or solvent extraction. They are subsequently cleaned, purified, and sometimes modified. In general vegetable fats are mixtures of mainly triglycerides, which are glycerols esterified with three fatty acids. Vegetable fats can have different properties depending upon their sources. They may be solid at room temperature, liquid at room temperature, or they may even be a combination of both. Examples of vegetable fats include coconut oil, olive oil, soybean oil, sunflower oil, high oleic sunflower oil, safflower oil, cottonseed oil, corn oil, shea butter, cocoa butter, peanut oil, grapeseed oil, rapeseed oil, rice bran oil, sesame oil, lineseed oil, pumpkin seed oil, illipe oil, sal oil, mango oil, and walnut oil.

The terms “vegetable fat”, “vegetable oil”, “plant-based fat”, and “plant-based oil” further include the plurals “vegetable fats”, “vegetable oils”, “plant-based fats”, and “plant-based oils”.

The vegetable fat, which is present in the composition in accordance with the present invention does not contains palm fat or palm oil.

The vegetable fat of the composition in accordance with the present invention furthermore has a solid fat content (SFC) at 20° C. from 15 to 25%. The crystallization and melting properties of a vegetable oil blend are responsible for many fundamental characteristics of fatty foods, such as physical appearance, organoleptic properties and spreadability, also influencing plasticity of an edible oil containing product. The solid fat content (SFC) measured across a temperature gradient is a useful and widely used indicator for these. Solid fat content (SFC) is a measure of the percentage of fat in crystalline (solid) phase to total fat (the remainder being in liquid phase) at a given temperature. It is determined via TD-NMR with the standard protocol described in IUPAC 2.150a. In essence the samples are molten completely and stabilized for 10 minutes at 80° C. and 60° C. consecutively and hold for 60 minutes isothermally at 0° C. Prior to measurement, the samples are stabilized at the respective measuring temperatures (10° C., 20° C., 25° C., 30° C., 35° C., 40° C.).

The SFCs at 20° C. for examples for pure fats measured according to IUPAC 2.150a are as follows:
coconut oil: 40.3%
rapeseed oil: 0%
sunflower oil: 0%
high oleic sunflower oil: 0%
lineseed oil: 0%
pumpkin seed oil: 0%
walnut oil: 0%
olive oil: 0%
shea butter: 15%
shea stearin: 79.9%
cocoa butter: 60.3%

The fat composition in accordance with the present invention furthermore comprises interesterified fats. Chemical or enzymatical interestification is a modification tool in the lipid industry to change the properties of a fat or fat mixture by changing the distribution of fatty acids over the present triglycerides. Resulting triglyceride mixture exhibits different crystallization and melting behavior compared to the original non-interestified fats. This is detectable in the measurement of the solid fat content as well. Preferably, cocoa butter and coconut oil, or shea stearin and coconut oil of the invention are interesterified.

In a preferred embodiment in combination with any of the above or below embodiments, vegetable fat is present in the composition in accordance with the present invention in an amount of 15 to 30 wt %, more preferably 20 to 30 wt %, in particular 25 to 30 wt %, based on the total weight of the composition.

The composition in accordance with the present invention further contains 65 to 90 wt % of water phase based on the total weight of the composition. In a particular preferred embodiment in combination with any of the above or below embodiments, the composition contains a water phase in an amount of 70 to 80 wt %, based on the total weight of the composition.

In another preferred embodiment in combination with any of the above or below embodiments, the composition in accordance with the present invention does not contain animal-based fats.

In a preferred embodiment in combination with any of the above or below embodiments, the protein content of the composition of the present invention is smaller than 1.0 wt %, more preferably smaller than 0.3 wt %, most preferably smaller than 0.1 wt %, based on the total weight of the composition. In a particular preferred embodiment, the composition in accordance with the present invention does not contain any protein.

In another preferred embodiment in combination with any of the above or below embodiments, the fatty acids in the vegetable fat, which is present in the composition in accordance with the present invention comprise C12, C18, and C18:1 fatty acids. More preferably, the fatty acids are 15 to 25 wt % C12, 9 to 20 wt % C18, and 24 to 42 wt % C18:1, based on the total weight of the vegetable fat.

In a further preferred embodiment in combination with any of the above or below embodiments, the composition in accordance with the present invention is in the form of an emulsion. More preferably, the composition is in the form of a cream.

In a preferred embodiment in combination with any of the above or below embodiments, the vegetable fat is a combination of two or more vegetable fats, more preferably a combination of 3, 4, 5, or 6 vegetable fats, most preferably a combination of 3 vegetable fats.

In a preferred embodiment in combination with any of the above or below embodiments, the vegetable fat present in the composition in accordance with the present invention is selected from shea stearin, shea butter, cocoa butter, coconut oil, rapeseed oil, sunflower oil, high oleic sunflower oil, linseed oil, pumpkin seed oil, walnut oil, olive oil, illipe oil, sal oil, mango oil, and soybean oil, or fractions and combinations thereof. More preferably, the vegetable fat is selected from shea stearin, shea butter, cocoa butter, coconut oil, rapeseed oil, sunflower oil, high oleic sunflower oil or fractions and combinations thereof. Most preferably, the vegetable fat is a combination of shea stearin, coconut oil and rapeseed oil, or shea stearin, coconut oil and high oleic sunflower oil, or cocoa butter, coconut oil and rapeseed oil, or cocoa butter, coconut oil and high oleic sunflower oil, or shea stearin, cocoa butter, coconut oil, rapeseed oil and high oleic sunflower oil. In particular, the vegetable fat consists of 22 to 36 wt % shea stearin and/or cocoa fat, 34 to 52 wt % coconut oil, and 24 to 35 wt % rapeseed oil and/or high oleic sunflower oil, based on the total weight of the vegetable fat, summing up to a total of 100 wt %.

In another preferred embodiment in combination with any of the above or below embodiments, the vegetable fat or the combination of two or more vegetable fats comprises coconut oil. Compositions comprising coconut oil have a mouthfeel very close to cow's cream.

In a further preferred embodiment in combination with any of the above or below embodiments, the composition in accordance with the present invention further comprises at least one additive selected from carbohydrates, colorants, flavorants, salt, and combinations thereof.

The quantities of the additives are expressed as wt % of the total weight of the water phase. As an example: the total weight of the composition is 100 g, of which 30 g is vegetable fat, 50 g is water, 10 g ( 1/7×100% of wt of water phase) is nOSA starch and 10 g ( 1/7×100% of wt of water phase) is carbohydrate.

In a preferred embodiment in combination with any of the above or below embodiments, the carbohydrate is present in an amount of from 1 to 5 wt %, more preferably 2 to 4 wt %, based on the total weight of the water phase of the composition. The carbohydrate is preferably selected from glucose, maltodextrin, soluble fiber or combinations thereof.

Fibers are non-digestible polysaccharides and non-digestible oligosaccharides, and are considered to be dietary fibers by their physiological or physical-chemical properties. Dietary fibers are non-digestible by present definition in that they are resistant to digestion and absorption in the human small intestine. Soluble fibers can be produced from plant based carbohydrates by a bio-enzymatic process providing consistent product characteristics regarding the degree of polymerization with a well-controlled level of oligomers and purity. They are highly soluble and with low caloric value. The nutritional value and sweet taste impact depends on the respective process used by the manufacturers.

Fructo-oligosaccharides (FOS) are soluble dietary fibers belonging to the family of fructans. They are slightly sweet and are used in a wide range of foodstuffs for nutrition (sugars replacement, fibre enrichment) and health purposes.

Actilight® is used as an ingredient to reduce sugars, enrich in fibers and improve gastro-intestinal health, due to its prebiotic effect.

Fibersol, Fibersol®-2, digestion resistant maltodextrin, is a spray-dried powder produced by a proprietary method of controlled enzymatic hydrolysis of cornstarch. It has numerous starch linkages that remain undigested by enzymes of the human digestive tract. It has been recognized as GRAS (generally recognized as safe) by the Food and Drug Administration and certified Kosher and Pareve by the Orthodox.

The soluble fiber in accordance with the present invention is an edible indigestible soluble carbohydrate polymer or a mixture thereof. The soluble fiber is selected from a plant source or produced by microorganisms such as resistant starch (RS), or a non-starch polysaccharide (NSP) with high molar weight or a low molar weight non-starch polysaccharide (prebiotics). In a preferred embodiment in combination with any of the above or below embodiments, the soluble fiber is a non-starch polysaccharide, which is selected from a citrus fiber, an apple fiber, a pea fiber, a potato fiber, a wheat fiber, pectin, a beta-Glucan (obtained from barley, oat, rye, from yeast/moulds fermentation), fiber processed from psyllium seed husks and a mixture thereof. In a further preferred embodiment in combination with any of the above or below embodiments, the soluble fiber is a non-starch polysaccharide, which is selected from resistant oligosaccharide (FOS/GOS), inulin (obtained from chicory, wheat), resistant maltodextrins/dextrin (Fibersol®) and polydexrose and a mixture thereof.

In a further preferred embodiment in combination with any of the above or below embodiments, the colorant is present in an amount of from 0.01 to 0.08 wt %, more preferably 0.02 to 0.06 wt %, based on the total weight of the water phase of the composition. The colorant is preferably a natural colorant, more preferably a colorant selected from turmeric extract, safflower extract, carotenoids, caramel color or combinations thereof.

In a preferred embodiment in combination with any of the above or below embodiments, the salt is present in an amount of from 0.01 to 0.5 wt %, more preferably 0.1 to 0.3 wt %, based on the total weight of the water phase. The salt is preferably sodium chloride.

In another preferred embodiment in combination with any of the above or below embodiments, the flavorant is present in an amount of from 0.01 to 1.0 wt %, more preferably 0.05 to 0.5 wt %, in particular 0.08 to 0.4 wt %, based on the total weight of the water phase.

In a further preferred embodiment in combination with any of the above or below embodiments, the composition in accordance with the present invention comprises 70 to 80 wt % of a water phase comprising 3 to 31 wt % of nOSA starch based on the total weight of the water phase, and 20 to 30 wt % of a vegetable fat blend, based on the total weight of the composition. Preferably, the vegetable fat blend consists of 22 to 36 wt % shea stearin and/or cocoa butter, 34 to 52 wt % coconut oil, and 24 to 35 wt % rapeseed oil and/or high oleic sunflower oil, based on the total weight of the vegetable fat, summing up to a total of 100 wt %. More preferably, the composition further comprises 1 to 5 wt % of at least one carbohydrate, 0.2 to 0.5 wt % salt, 0.05 to 0.5 wt % of at least one flavorant, and 0.05 to 0.15 wt % of at least one colorant based on the total weight of the water phase.

In another preferred embodiment in combination with any of the above or below embodiments, the composition in accordance with the present invention does not contains allergens. Typical allergens are peanuts, gluten, celery.

The present invention further relates to a food product additive comprising the composition according to the present invention.

The present invention further relates to a food product comprising the composition, or food-product additive of the present invention.

Food product (additive) is potato gratin, casserole dish, soup, ready meal, confectionary, sauce, dressing, cake, cooky, or oven dish.

In a preferred embodiment in combination with any of the above or below embodiments, the food product is a beverage, more preferably the beverage is milk, coffee, chocolate, tea, a sparkling alcoholic beverage (such as beer, cider, fruit wine), a non-alcoholic beverage (such as lemonade, fruit juice nectar), water, club soda, seltzer, mineral water, milk, or plant-based juice/broth, vegan milk from soy, oat, rice, flax, pea, coconut, almond, cashew, hazelnut, macadamia, or peanut, or any combination thereof.

In a further preferred embodiment in combination with any of the above or below embodiments, the food product or food product additive comprises at least one extract of an edible plant or part of an edible plant. More preferably, the extract of an edible plant or part of an edible plant is an extract of a plant selected from the group consisting of a vegetable, a fruit, a herb, a spice, a seed, tea, cocoa and coffee, more preferably a vegetable, a fruit, a herb, tea and coffee. The plant extract can be selected from a juice, a puree, a concentrate, an infusion, a powder and a ferment/brew.

According to the present invention, the term “plant extract” is used representatively for all products that are obtained from an edible plant or part of an edible plant by squeezing or by means of an extraction with a solvent, such as with maceration or percolation. An extract obtained in this way can subsequently be further processed into a dry extract. To produce the dry extract, the solvent can be withdrawn from the liquid raw extract, the concentrated extract or the cleaned extract by, for example, spray drying, freeze drying or vacuum drying.

The plant extract used according to the present invention may also include a plant juice. The term “juice” is used representatively for the natural fluid, fluid content, or liquid part that can be obtained from a plant or one of its parts, by squeezing, pressing or comminuting.

The plant extract used according to the present invention may also include a plant concentrate. The term “concentrate” is used representatively for all products that are obtained from a plant by means of removal of water from the fresh plant or from the respective juice. A dry plant product, such as a powder, is also included in the term “concentrate”.

In a further preferred embodiment in combination with any of the above or below embodiments, the extract is a fruit extract and the fruit is selected from berries, e.g. açai berry blackberry, blackcurrant, blueberry, boysenberry, cranberry, elderberry, grape, gooseberry, kiwi, raspberry, redcurrant or strawberry; citrus fruits, e.g. blood orange, bitter orange, citron, clementine, grapefruit, pink grapefruit, kumquat, lemon, lime, mandarin, or orange; drupes, e.g. acerola, apricot, cherry, coconut, coffee, date, lychee, mango, mirabelle, nectarine, olive, peach or plum; melons, e.g. canary melon, cantaloupe melon, honeydew melon or watermelon; pomes, e.g. apples, pears, quince or chokeberry; succulent fruits, e.g. dragon fruit or prickly pear fruit; tropical and tropical-like fruits, e.g. banana, cacao, cherimoya, cashew apple, fig, guava, jackfruit, papaya, passionfruit, persimmon, pineapple, pomegranate, purple mangosteen, star fruit, tamarind or vanilla; plants with edible fruit-like structures, e.g. rhubarb; and nuts and nut-like fruits and seeds, e.g. chestnut, hazelnut, almond, cashew, coconut, pecan nut, pistachio, walnut, pine nut, macadamia, tonka bean or peanut. Preferably, the fruit is selected from berries such as raspberry, strawberry, blackcurrant or blueberry, from drupes such as apricot, cherry, coconut, coffee, lychee, mango, mirabelle, nectarine, olive, peach or plum, from pomes such as apples, pears or quince, from tropical fruits such as passion fruit, pineapple, banana, cacao, passionfruit, pomegranate or vanilla, citrus fruits such as orange, bitter orange, citron, grapefruit, pink grapefruit, lemon, lime or mandarin, from plants with edible fruit-like structures such as rhubarb, nuts or nut-like fruits and from seeds such as chestnut, hazelnut, almond, coconut, pecan nut, pistachio or peanut.

In a preferred embodiment in combination with any of the above or below embodiments, the extract is an extract of edible parts from a vegetable e.g., bulbs, flowers, fungi, leaves, roots, seeds, stems or tubers such as, but not limited to amaranth, artichoke, asparagus, avocado, azuki bean, beet greens, beetroot, bell pepper/capsicums, broccoli, brussels sprouts, cabbages, carrots, cauliflower, celeriac, celery, chilli peppers, courgette, cucumber, eggplant, fennel, garlic, ginger, kohlrabi, leeks, lettuce, liquorice, melons, mushrooms, okra, onions, parsnips, peas, potatoes, puha, pumpkins, radishes, rhubarb, salad green, shallot, spinach, spring onions, sprouted beans and seeds, sweet corn, taro, tomatoes, topinambur, turnips, watercress, witloof/chicory, or yams. Preferably, the vegetable is selected from artichoke, asparagus, avocado, beet greens, beetroot, bell pepper/capsicums, broccoli, brussels sprouts, cabbages, carrots, cauliflower, celeriac, celery, chilli peppers, courgette, cucumber, eggplant, fennel, garlic, ginger, kohlrabi, leeks, melons, mushrooms, onions, parsnips, peas, potatoes, pumpkins, radishes, rhubarb, shallot, spinach, spring onions, sweet corn, tomatoes, turnips.

In another preferred embodiment in combination with any of the above or below embodiments, the herb is selected from the group consisting of basil, borage, celery, chervil, chives, coriander, curry, dill, Fenugreek, garlic, hibiscus, laurel, lavender, lemongrass, lovage, majoram, peppermint, spearmint, oregano, parsley, rosemary, sage, savory, tarragon and thyme. Preferred herbs are basil, borage, celery, chervil, chives, coriander, curry, dill, Fenugreek, garlic, hibiscus, kaffir lime, laurel, lavender, lemongrass, lovage, majoram, peppermint, spearmint, oregano, parsley, rosemary, sage, savory, tarragon and thyme or a mixture thereof e.g. herbes de provence.

According to the present invention, the term “herb” encompasses the green leafy part as well as the flower such as lavender flowers.

In another preferred embodiment in combination with any of the above or below embodiments, suitable spices are selected from the group consisting of aniseed, cardamom, celery, chillies, cinnamon, cassia, cloves, coriander, cumin, dill, fennel, fenugreek, galangal, garlic, ginger, grains of paradise, horseradish, juniper berries, mace/nutmeg, mustard, nigella, onion, paprika, pepper (green, black, white, red), pink pepper, sichuan pepper, pimento, poppy seed, saffron, sesame seed, star anise, sumac, tonka bean, turmeric, vanilla pod and wasabi. Preferably, the spice is selected from aniseed, cardamom, celery, chillies, cinnamon, cloves, coriander, cumin, dill, fennel, fenugreek, galangal, garlic, ginger, horseradish, juniper berries, mace/nutmeg, mustard, onion, paprika, pepper, pimento, saffron, star anise, sumac, turmeric, vanilla pod and wasabi.

According to the present invention, the term “spice” encompasses a seed, fruit, root, stem, bark, flower or parts thereof which are primarily used for flavoring, coloring or preserving food.

In a further preferred embodiment in combination with any of the above or below embodiments, the extract of an edible plant or part of an edible plant is a mixture of one or more of the above mentioned plant extract.

In a further preferred embodiment in combination with any of the above or below embodiments, the food product further comprises a food extract.

In another preferred embodiment in combination with any of the above or below embodiments, the food extract is a dairy product, primarily produced from mammals such as cattle, water buffaloes, goats, sheep, camel or a mixture thereof. Suitable dairy products are a milk product, a cream product, a butter product, a fermented dairy product, a custard product, a cheese product, and a whey product. Preferably, the dairy product is selected from a spreadable cheese product, a processed cheese product, a cheese powder, a cream concentrate, a sweetened milk concentrate, a condensed milk, a cream cheese, a yoghurt or butter.

In a further preferred embodiment in combination with any of the above or below embodiments, the food extract is a condiment or a sauce, such as aioli, ajvar, chatni, chutney, green sauce, guacamole, HP sauce, hummus, ketchup, marmite, pesto, tahini, tapenade, garam masala, tandoori masala, or Raz el-Hanout.

In a preferred embodiment in combination with any of the above or below embodiments, the food extract and the extract of an edible plant or parts thereof is present in the food product or food product additive in an amount of 0.1 to 60% by weight, based on the total weight of the food product or food product additive, more preferable in an amount of 1.0 to 50 wt %, and most preferably 10 to 40% by weight, based on the total weight of the food product or food product additive.

The present invention also provides a container, comprising the composition, food-product additive, or food product of the present invention.

In a preferred embodiment in combination with any of the above or below embodiments, the container is a pressurized container comprising a pressurized gas at a pressure of from 10 to 30×10⁵ Pa.

In a further preferred embodiment in combination with any of the above or below embodiments, the pressurized gas is selected among air, nitrogen, carbon dioxide, nitrous oxide, helium, oxygen and mixtures thereof. Such a pressurized container may comprise a valve allowing to introduce the pressurized gas and an opening for dispensing the foamed composition.

In another preferred embodiment in combination with any of the above or below embodiments, the container is a sterile soft package or a stainless steel container.

The present invention also relates to a method for producing the composition according to the present invention.

In a preferred embodiment in combination with any of the above or below embodiments, a solution of nOSA starch in water is prepared, wherein the water has a temperature of 20 to 80° C., more preferably 20 to 70° C., most preferably 30 to 50° C.

In another preferred embodiment in combination with any of the above or below embodiments, the solution of nOSA starch in water is emulsified with a vegetable fat with a high shear system at a temperature of 20 to 70° C., more preferably 30 to 60° C. In case that the vegetable fat is a solid fat, the fat is melted before emulsification. Preferably, the melting is carried out at a temperature of 30 to 70° C.

In a further preferred embodiment in combination with any of the above or below embodiments, the emulsion obtained in the emulsifying step is homogenized with a pressure of 50 to 400 bar, more preferably 50 to 300 bar, particularly preferably 50 to 200 bar.

In a preferred embodiment in combination with any of the above or below embodiments, the emulsion is further subjected to an UHT treatment at a temperature of 130 to 140° C. for a time of 5 to 20 seconds.

Surprisingly, the composition in accordance with the present invention is stable under UHT heat treatment, pasteurization and provides a long term storage stability of more than 4 weeks at a temperature of 5° C. and also at a temperature from 20 to 25° C. When prepared as a liquid emulsion, the composition in accordance with the present invention provides a good tasting food emulsion similar to cow's milk cream.

### EXAMPLES

The following examples further describe the invention. Comparative Examples 1 and 2 are out of the described ranges of the invention, in particular, the SFC of the vegetable fat at 20° C. is not 15 to 25%, and do not meet olfactorily properties similar to cow's milk cream. Example 3 does not contain palm fat, no proteins, is stable after UHT treatment and is good in taste, similar to cow's milk cream.

### Comparative Example 1

TABLE 1
Overview of composition of Comparative Example 1

| Emulsion | Further Composition of water/ | Quantities of final |
|---|---|---|
| composition | lipid phase | composition |
| Water Phase | 21.4 wt % nOSA starch | 70 wt % |
| | 0.28 wt % Sodium Chloride | |
| | 0.35 wt % Flavor | |
| | 0.03 wt % Coloring Extracts | |
| | 2.9 wt % Glucose | |
| | 75.04 wt % water | |
| Lipid Phase | High Oleic Sunflower Oil | 30 wt % |

The SFC of the lipid phase at 20° C. is 0%.

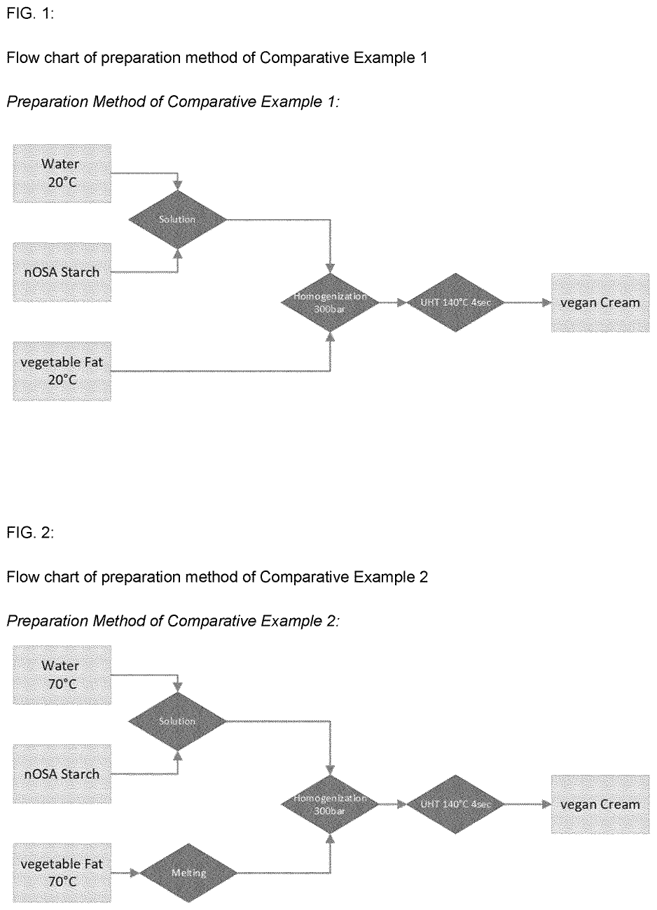

Comparative Example 1 is prepared as shown in FIG. 1. The nOSA starch is dissolved in water having a temperature of 20° C. Vegetable fat having a temperature of 20° C. is added and the mixture of the lipid phase and the water phase is homogenized at 300 bar, followed by UHT treatment at 140° C. for 4 seconds.

### Comparative Example 2

TABLE 2
Overview of composition of Comparative Example 2

| Emulsion | Further Composition of | Quantities of final |
|---|---|---|
| composition | water/lipid phase | composition |
| Water Phase | 18.75 wt % nOSA starch | 80 wt % |
| | 0.28 wt % Sodium Chloride | |
| | 0.31 wt % Flavor | |
| | 0.03 wt % Coloring Extracts | |
| | 2.8 wt % Glucose | |
| | 77.83 wt % Water | |
| Lipid Phase | 90 wt % fully hydrogenated | 20 wt % |
| | palm oil | |
| | 10 wt % fully hydrogenated | |
| | coconut oil. | |

The SFC of the lipid phase at 20° C. is 95.6%.

Comparative Example 2 is prepared as shown in FIG. 2. The nOSA starch is dissolved in water having a temperature of 70° C. Vegetable fat is melted at a temperature of 70° C. The mixture of the water phase and lipid phase is homogenized at 300 bar, followed by UHT treatment at 140° C. for 4 seconds.

### Example 3

TABLE 3
Overview of composition of Example 3

| Emulsion | Further Composition of | Quantities in |
|---|---|---|
| composition | water/lipid phase | final product |
| Water Phase | 8.3 wt % nOSA starch | 72 wt % |
| | 0.3 wt % Sodium Chloride | |
| | 0.35 wt % Flavor | |
| | 0.03 wt % Coloring Extracts | |
| | 2.9 wt % Glucose | |
| | 88.12 wt % Water | |
| Lipid Phase | 40 wt % Cocoa butter (80 | 28 wt % |
| | wt %) interestified with | |
| | Coconutoil (20 wt %) | |
| | 30 wt % High Oleic | |
| | Sunflower Oil | |
| | 30 wt % Coconut oil | |

The SFC of the lipid phase at 20° C. is 19.1%.

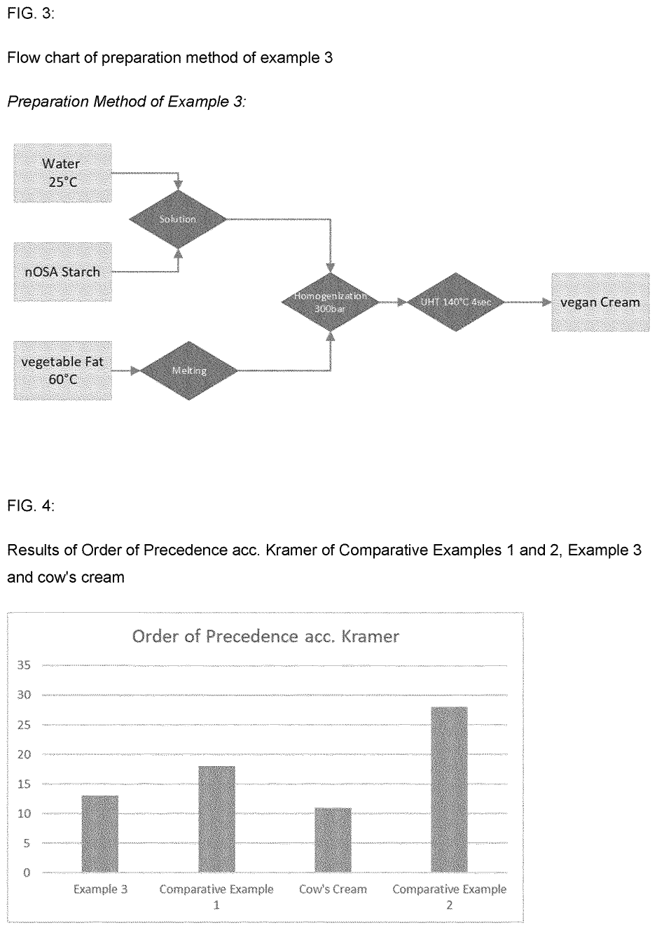

Example 3 is prepared as shown in FIG. 3. The nOSA starch is dissolved in water having a temperature of 25° C. Vegetable fat having a temperature of 60° C. is added and the mixture of the lipid phase and the water phase is homogenized at 300 bar, followed by UHT treatment at 140° C. for 4 seconds.

### Organoleptic Evaluation of Samples

The samples were evaluated using a tasting session. Samples of the composition according to the three examples together with a cow's cream were presented blinded and in randomized order to 7 persons. The question was asked to rank the samples in order of liking (preference): Rank 1 should be assigned for the best tasting sample up to Rank 4 for the worst tasting sample. All ranks were summed up and the results are shown in FIG. 4.

According to this method the lowest sum identifies the best tasting sample and the highest sum identifies the worst sample. As can be seen in FIG. 4, the inventive composition (Example 3) and cows cream are the samples with the lowest sum (11 for cows cream and 13 for Example 3—1^{st} and 2^{nd} place). Comparative Example 1 (with an oil phase liquid at room temperature-sunflower oil) is ranked on 3^{rd} place with a sum of 18 and Comparative Example 2 (with an oil phase solid at room temperature-fully hydrogenated palm and coconut oil) ranks on 4th place with a sum of 28.

It is concluded, that only the inventive composition is close to the organoleptic properties of cow's cream.

1. A composition comprising:
10 to 35 wt % of vegetable fat based on the total weight of the composition, and 65 to 90 wt % of water phase based on the total weight of the composition, summing up to a total of 100 wt %;
wherein 3 to 31 wt % of the total weight of the water phase is nOSA starch,
wherein the vegetable fat does not contain palm fat, and
wherein the solid fat content (SFC) of the vegetable fat of the composition at 20° C. is from 15 to 25%.

2. The composition according to claim 1, wherein the protein content is smaller than 1.0 wt %,
more preferable smaller than 0.3 wt %,
most preferable smaller than 0.1 wt %,
based on the total weight of the composition.

3. The composition according to claim 1, wherein the fatty acids in the vegetable fat comprise C12, C18, and C18:1 fatty acids.

4. The composition according to claim 3, wherein the fatty acids are:
15 to 25 wt % C12,
9 to 20 wt % C18, and
24 to 42 wt % C18:1,
based on the total weight of the vegetable fat.

5. The composition according to claim 1, wherein the vegetable fat comprises interesterified fats.

6. The composition according to claim 1, wherein the composition is an oil-in-water emulsion.

7. The composition according to claim 1, wherein the vegetable fat is selected from coconut oil, rapeseed oil, sunflower oil, high oleic sunflower oil, linseed oil, pumpkin seed oil, walnut oil, olive oil, shea butter, shea stearin, and cocoa butter, or combinations thereof.

8. The composition according to claim 7, wherein the vegetable fat is a combination of (a) cocoa butter, coconut oil and rapeseed oil, or (b) cocoa butter, coconut oil and high oleic sunflower oil, or (c) shea stearin, cocoa butter, coconut oil, rapeseed oil and high oleic sunflower oil, or (d) shea stearin, coconut oil and rapeseed oil, or (e) shea stearin, coconut oil and high oleic sunflower oil.

9. The composition according to claim 1, further comprising an additive selected from carbohydrates, colorants, flavorants, salt, and combinations thereof.

10. The composition according to claim 1, wherein the vegetable fat consists of:
22 to 36 wt % shea stearin or cocoa butter,
34 to 52 wt % coconut oil, and
24 to 35 wt % rapeseed oil or high oleic sunflower oil, based on the total weight of the vegetable fat,
summing up to a total of 100 wt %.

11. The composition according to claim 1, wherein the composition does not contain one or more of peanut, gluten, or celery allergen.

12. A food product additive comprising the composition according to claim 1.

13. A food comprising the composition or food product additive according to claim 1.

14. The food product according to claim 13, wherein the food product is potato gratin, casserole dish, soup, ready meal, confectionary, sauce, dressing, cake, cooky, or oven dish.

15. A method comprising adding Use of the composition of claim 1 to a food product.

16. A container comprising the composition of claim 1.

17. The container according to claim 16, wherein the container is a pressurized container, a sterile soft package, or a stainless steel container.

18. A method for producing the composition according to claim 1, comprising the steps of:
a) preparing a solution of nOSA starch in water, wherein the water has a temperature of 10 to 80° C.,
b) emulsifying the nOSA starch solution of step a) with a vegetable fat to obtain an emulsion;
c) optionally homogenizing the emulsion of step b); and
d) subjecting the emulsion to UHT treatment at a temperature of 130° C. to 145° C. for 5 to 20 seconds.
